(19) United States
(12) Patent Application Publication
(10) Pub. No.: US 2006/0156892 A1
(43) Pub. Date: Jul. 20, 2006

(54) Saw blade for circular saws

(75) Inventor: Pedro Farrarons Losse, Barcelona (ES)

Correspondence Address: James Michael Faier;Faier & Faier P.C., No. 600, 566 W. Adams St., Chicago, IL, 60661, US

(73) Assignee: Herramientas Preziss, S.L.

(21) Appl. No.: 11/130,540

(22) Filed: May 17, 2005

(30) Foreign Application Priority Data
Jan. 19, 2005 (ES) 0200500106

(51) Int. Cl. B23D 57/00

(52) U.S. Cl. 83/835

(57) ABSTRACT

A blade or disk for a rotary or circular saw having cutting teeth on the periphery of the blade, wherein some of the teeth are of a more costly, aggressive, or long wearing material such as polycrystalline diamond and some of the teeth are of a less costly, aggressive or long wearing material such as tungsten carbide, and where such teeth may be fabricated in different configurations.

### CLAIM OF PRIORITY

This application claims priority from Spanish Utility Model No. 200500106, filed 19 Jan. 2005.

### FIELD OF THE INVENTION

The present invention relates to a blade or disk of the type used as a cutting element in circular saws, that is to say of the type which consists of a main circular member which may be coupled by its centre to the shaft of a rotary saw machine and provided at its periphery with a plurality of cutting teeth.

The object of the invention is to provide a blade or disk which combines optimum functional features with reduced manufacturing costs.

### BACKGROUND OF THE INVENTION

Blades or disks for circular saws comprise at their periphery a plurality of teeth which may assume varying configurations from one disk to another, and even on one and the same disk, the cutting edge of which teeth is obtained by soldering to the teeth of the steel body a cutting tip which is usually made from two different types of material, the raw material used being in some cases polycrystalline diamond (PCD) and in other cases tungsten carbide (WC).

Polycrystalline diamond is much harder than tungsten carbide, so that it has a better cutting action and is also much more resistant to wear; however, on the other hand, it is a lot more expensive. Other materials may also be used for the teeth of the blade, and each may have varying cutting characteristics and cost.

In accordance with the above, the basis for the choice between the types of disk on the market is fundamentally economic, since disks whose teeth have a cutting edge of polycrystalline diamond or other selected expensive aggressive or long lasting cutting material could be put to general and exclusive use, given that they provide optimum features with regard to cutting any type of material and better performance, but nonetheless in many cases the use of tungsten carbide or material which are less costly or long lasting are selected for reasons of cost.

Although the optimum material is polycrystalline diamond or other high cost material, the need to keep costs in check is a hindrance to its widespread industrial use in the manufacture of saw disks.

### SUMMARY OF THE INVENTION

The circular saw disk that is the subject of the invention provides features similar to those of conventional disks with cutting tips of polycrystalline diamond or other aggressive or long last material was devised and designed to provide a notable reduction in the cost thereof without reaching the cost level of those using tungsten carbide or less costly materials.

To this end, more specifically and in accordance with the invention, the central feature of the proposed disk is the fact that its teeth exhibit a combination of more expensive or long lasting material such as polycrystalline diamond and of less expensive or long lasting material such as tungsten carbide cutting tips.

In accordance with another of the features of the invention, the cutting tips of more expensive diamond and of less expensive tungsten carbide are arranged alternately around the periphery of the disk when all the cutting tips are of identical configuration, while, when the disk exhibits cutting tips of two or more different configurations, pairs or groups of tips of each of the materials are disposed alternately on the periphery of the disk, each pair comprising groups of cutting tips of both or multiple configurations.

Although this configuration, based on two different types of cutting tips, is the most usual and effective, the invention is equally applicable to any other type of combination with regard to the grouping of different types of teeth, both with regard to the number of different configurations for said teeth and to the number of teeth of each type or configuration.

In any case, the number of cutting tips of polycrystalline diamond or more aggressive or long lasting or more expensive material is less than the total number of saw teeth, which puts the overall cost of the disk approximately midway between the cost of a conventional polycrystalline diamond or similar blades or disks and a blade of disk of tungsten carbide or similar material, while providing virtually the same functional features as the former.

### OBJECTS OF THE INVENTION

It is the object of the invention to provide a blade for a rotary saw having cutting teeth of the character recited.

Another object is to provide a rotary saw blade having cutting teeth of varying materials on the same cutting disk

Another object is to provide a rotary saw blade where the cutting teeth of different materials are arranged alternately on the same cutting disk.

Another object is to provide a rotary saw blade where the cutting teeth of different materials are arranged in a variety of shapes on the same cutting disk.

Another object is to provide a rotary saw blade of the character described which is effective and economical and relatively easy to make and to use.

### BRIEF DESCRIPTION OF THE DRAWINGS

To complement the description which follows and in order to assist in a better understanding of the features of the invention, in accordance with a preferred practical example of embodiment thereof, there is attached to said description, as an integral part thereof, a set of drawings in which, by way of non-limiting illustration, in which:

FIG. 1 is a schematic, front elevational representation of the different types of conventional teeth or tips for a rotary saw blade which embody the invention and comprise at least two of the above-mentioned materials, and the arrangement of said tips on the teeth of the disk as a function of the different natures of the cutting teeth or tips thereof, when the tips used on the disk are all of the same configuration.

FIG. 2: is a modified schematic, elevation view similar FIG. 1, except showing different examples of groupings or pairs of teeth or tips of different configurations and the arrangement thereof on the teeth of the saw disk.

### DESCRIPTION OF PREFERRED EMBODIMENTS

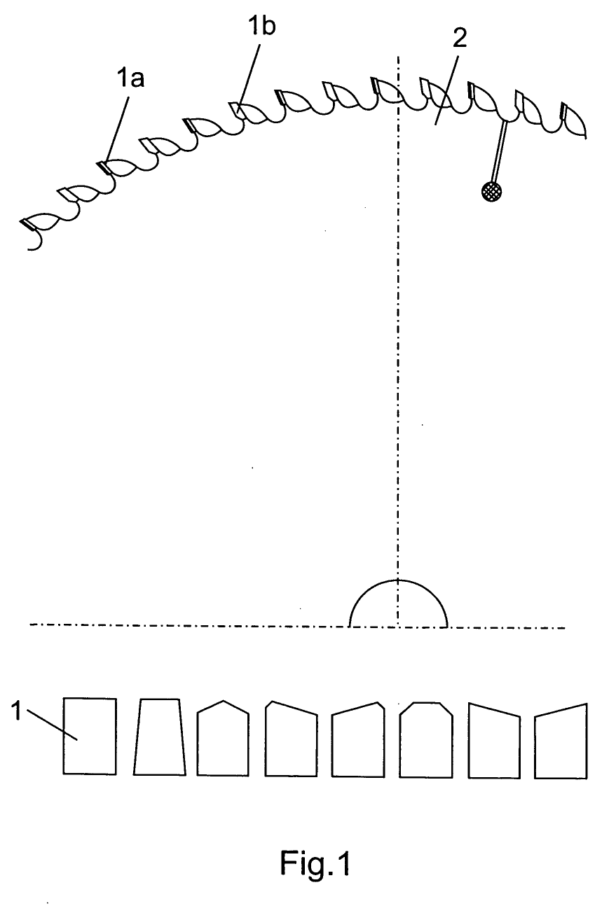

The described Figures, and in particular FIG. 1, show how, on the saw disk embodying the invention, and more specifically on the teeth around the periphery thereof, different types of cutting teeth or tips 1, which may have a conventional shape that is flat, conical, trapezoidal, left or right bevelled, etc. Irrespective of the shape of cutting tip 1 used, which may be any one of those cited above, when a single type of tooth or tip 1 is used, as also illustrated in FIG. 1, there are disposed around the periphery of the blade or disk 2 teeth of a first material, such as polycrystalline diamond tips 1a, and teeth of a second material, such as tungsten carbide tips 1b, all on the same blade. These tips of difference material may be arranged alternately, that is to say each tooth with a diamond tip being flanked by two teeth with tungsten carbide tips and vice versa.

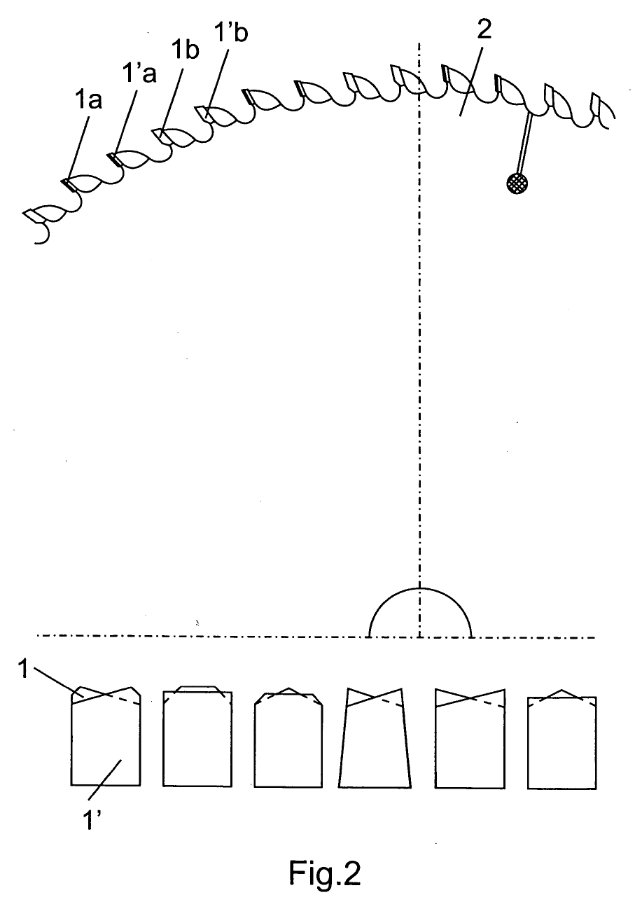

As illustrated in FIG. 2, a single disk 2 may use cutting tips 1-1′ of different configurations, specifically teeth or tips with two distinct types of configuration, as shown in said Figure, for example, a combination of a left beveled tip 1 with a right beveled tip 1′ or a tip forming a flat tooth with a tip forming a trapezoidal tooth etc. In this case, and as is also shown in FIG. 2, the tips of different shape configurations are disposed alternately, in such a way, for example, that each tooth with a left beveled tip 1 is followed by a tooth with a right beveled tip 1′, in groups which are in turn alternately of different materials, in such a way that the periphery of the disk exhibits a tooth of a first material, such as a polycrystalline diamond tip 1a, is immediately followed by a similar tooth 1′a, also with a diamond tip, followed by a tooth of a second material, such as a tip 1b of tungsten carbide, followed by a similar tooth l′b of tungsten carbide, this sequence being continued without interruption around the entire periphery of the disk 2.

In this way, a considered choice is made with regard to the distribution of the teeth around the periphery of the blade or disk, as a function of the different hardness grades of the two materials used for the cutting tips, thus ensuring that the cuts made by the different teeth are fully effective and, consequently, that cutting quality is optimum, all this being achieved in conjunction with the reduction in cost obtained by replacing some of the more expensive polycrystalline diamond cutting tips with less expensive tungsten carbide cutting tips.

The embodiments described and illustrated in the drawings are simply preferred practical examples of embodiment, since in reality, and as stated above, a single disk may exhibit more different tooth configurations, in variable numbers within each configuration, without going beyond the scope of the invention.

While preferred embodiments of the invention have been shown and described, modifications and changes in the structure and arrangement and shape of the cutting teeth can be made without departing from the spirit or scope of the invention. Accordingly, it is desired that the invention should not be limited to the exact structure disclosed.

1. A blade for a rotary saw of the type having at its periphery a plurality of teeth provided with cutting tips, said plurality of teeth being on the same blade and comprising a first set of cutting tips fabricated from one material and a second set of cutting tips fabricated from a second material.

2. In the rotary saw blade recited in claim 1, wherein said first set of cutting tips are of polycrystalline diamond material.

3. In the rotary saw blade recited in claim 1, wherein said second set of cutting tips are of tungsten carbide.

4. In the rotary saw blade recited in claim 1, wherein said sets of cutting tips are evenly distributed around the periphery of said blade.

5. In the rotary saw blade recited in claim 1, wherein all said cutting tips are of the same shape configuration.

6. In the rotary saw blade recited in claim 1, wherein a tooth having a tip of said first set is arranged alternatively with a tooth having a tip of said second set and flanked by two teeth having tips of said second set, and vice versa.

7. In the rotary saw blade recited in claim 1, wherein said teeth have different shape configurations and one of said tips of one different shape configuration is arranged alternately on the periphery of said blade with a tip of another different shape.

8. In the rotary saw blade recited in claim 1, wherein said tips of each of said sets are arranged in a group with a tip of one configuration and another group with tips of another configuration.

9. In the rotary saw blade recited in claim 8, wherein said group of a first set is arranged alternately with said group of said second set.

10. In the rotary saw blade recited in claim 1, wherein said teeth with tips of said first set are arranged around said periphery with tips of said second set, and with more teeth of one different shape configuration in equal proportions with teeth of another different shape configuration.

11. In the rotary saw blade recited in claim 1, wherein said teeth with tips of said first set are arranged around said periphery with tips of said second set, and with more teeth of one different shape configuration in different proportions with teeth of another different shape configuration.

12. In the rotary saw blade recited in claim 1, wherein said teeth with tips of said first set are more aggressive that said teeth with tips of said second set.
